(19) United States
(12) Patent Application Publication
(10) Pub. No.: US 2004/0252319 A1
(43) Pub. Date: Dec. 16, 2004

(54) System and method for multiple print stream management and finishing

(76) Inventors: Mark Van Gorp, Cary, NC (US); Lenny Neifert, Apex, NC (US); Gerard DeRome, Cary, NC (US); Barry Hageter, Cary, NC (US); Douglas Cowles, Apex, NC (US); Neal Middleburg, Apex, NC (US)

Correspondence Address: MCDERMOTT, WILL & EMERY, 600 13th Street, N.W., Washington, DC, 20005-3096, US

(21) Appl. No.: 10/615,590

(22) Filed: Jul. 9, 2003

Related U.S. Application Data
(60) Provisional application No. 60/394,256, filed on Jul. 9, 2002.

(51) Int. Cl. G06F 15/00

(52) U.S. Cl. 358/1.13; 358/1.1

(57) ABSTRACT

The multiple print stream management system for managing production of a document to be created divided into document portions includes a printing stage including a plurality of printers each for printing a respective document portion of the document to be created; a finishing stage including one or more assembly devices for processing an output of each of the plurality of printers for collating the document portions into a final document corresponding to the document to be created; and a processor for tracking each document portion and for directing collation of the document portions in accordance with intended attributes of the final document specified in a data file for the document to be created.

### CROSS-REFERENCE TO PROVISIONAL APPLICATION

This application claims the benefit of U.S. Provisional Application No. 60/394,256 entitled “METHOD FOR MULTIPLE PRINT STREAM MANAGEMENT AND FINISHING SYSTEM” filed on Jul. 9, 2002, the disclosure of which is entirely incorporated herein by reference.

### FIELD OF THE INVENTION

The present subject matter relates to a document print system that uses multiple print resources, collates the document, and tracks each portion of the document during the process as well as during any subsequent finishing operations.

### BACKGROUND OF THE INVENTION

Prior to cost effective digital color printing, businesses typically used offset printing, which is not without its disadvantages. Offset printing typically requires lithography to form plates, which limits variability in the documents. The use of offset printers transitioned to faster and cheaper black and white printers for personalized or individual documents. Although such printing techniques can produce large quantities of color pages in an efficient cost effective manner, due to the lack of variability, they can not readily produce distinctly different individual documents.

With the advances in print on demand growing at about 100% a year, many businesses have transitioned to digital printing, which offers shorter job runs and increased turn around times. Digital printing allows on-demand production of individual documents, for example, personalized correspondence. However, early digital printing equipment, particularly for high volume work was only black and white. The power of color has far more effective marketing spin, which has driven customers to choose digital color printed documents as the preferred medium. The cost of digital color printing remains high relative to black and white and offset printing. To combat this problem, businesses typically will manually collate black and white or offset printer documents with digital color documents. However, to date, the collation has been a labor intensive manual process. Literally, rows and rows of people sit at tables and manually collate documents. In addition to the expense, there is no tracking and no real integrity in the process. The present system is plagued with human error.

As a result, businesses are faced with a core limitation of print systems: the inability to print a document using multiple print resources, automatically compile the document, and monitor the process while ensuring high integrity. Hence, a need exists for an enhanced technique for printing a document using multiple resources, tracking the document at all stages, and compiling the document while maintaining superior integrity at all times.

### SUMMARY

The concepts disclosed herein alleviate the above noted problems by providing automated document production using multiple printing resources, automated tracking, automated verification, and automated collation.

The concepts address the system and method by which one composes a document for maximum impact, low cost, high speed, and high integrity. The processing allows a user to essentially send a first portion of a document to first printing resource, and a second portion to a second resource for color digital printing. The portions of the document are then merged with one another to form the complete document. During the entire process, each component of the document is track thereby increasing speed and integrity.

More specifically, the multiple print stream management system for managing production of a document to be created divided into document portions, comprising: a printing stage including a plurality of printers each for printing a respective document portion of the document to be created; a finishing stage including one or more assembly devices for processing an output of each of the plurality of printers for collating the document portions into a final document corresponding to the document to be created; and a processor for tracking each document portion and for directing collation of the document portions in accordance with intended attributes of the final document specified in a data file for the document to be created.

The data file is created for every document or for a group of documents. The data file tracks all the characteristic information pertaining to the document portions, and in particular, tracks which printing process the document portion is going through, whether or not it is completed, etc. The data file also defines the workflow. Therefore, if a document is to go to inserting or binding, for example, the file would indicate the same.

In addition to a data file, identifiers on each document page identify pertinent information. The identifier may include bar codes or be in the form of a logo on the corners of the document. Recoginition equipment is set up to do pattern matching based on the identity information on the document and from the data file. The data file identifies not only what document portions come together and in what sequence but also the order. The data file also maintains printing process information. Therefore, if an error occurs during the process, one can generate an automatic reprint.

During the process, each document portion or each document page is scanned and compared to a data file storing document information. When the document progresses to the finishing stage, a primary document component is identified as the control document. Scanning devices detects the account number or identifier, verifies all of the appropriate components have been accounted for, where each component should be fed from, and validates and verifies each and every document page.

More specifically, the process or method for collating and tracking portions of a document to be created from multiple print resources, comprising the steps of compiling attributes of a final document corresponding to the document to be created; obtaining from multiple print resources portions of the document to be created; collating the document portions into the final document; detecting an identifier on each document page or a group of document pages of the document to be created; comparing the detected identifier with the compiled final document attributes; and verifying collation of the document portions from the comparison.

The embodiment also covers the ability to incorporate non-printed items into the final merged document. Examples of non-printed items could be credit cards. Therefore, if there is to be a credit card matched to a package, the information would be populated in the data file that would identify an appropriate auxiliary add-in and verify the correct credit card was included in the correct package

The embodiment is also a cohesive system, which allows one to compose a document and process the document based on one's business needs. For instance, the system allows one to perfect the data file in accordance with the most effective business solution based on the desired output, and automates the finishing as well as the process to track the document.

The embodiment also covers the ability to operate without the use of a database. This is accomplished by incorporating all necessary information in the codes of each document page. In this way, the embodiment accommodates users of the print steam management system who may not have ready access to a database.

Additional objects, advantages, and novel features of the embodiments will be set forth in part in the description which follows, and in part will become apparent to those skilled in the art upon examination of the following and the accompanying drawings or may be learned by practice of the invention.

### BRIEF DESCRIPTION OF THE DRAWINGS

The drawing figure(s) depict preferred embodiments by way of example, not by way of limitation. In the figures, like reference numerals refer to the same or similar elements.

FIG. 1 is a simplified flow diagram of a print stream management system.

FIG. 2 is a more detailed flow diagram of one embodiment of the print management system as illustrated by FIG. 1.

FIG. 3 illustrates examples of detectable identifiers positioned on each document page.

FIG. 4 is a functional block diagram of a PC or workstation.

FIG. 5 illustrates a simplified block diagram of the print merge device.

FIG. 6 illustrates a flow chart of the process by which the document is printed, tracked, and collated.

FIG. 7 illustrates a flow chart of the reconciliation process.

### DESCRIPTION

Businesses have applied an ever-increasing demand for print-on-demand systems using multiple print resources, which keep cost low and maintain a high integrity. The various embodiments disclosed herein relate to systems and methods for implementing and automatically printing document portions using multiple print resources, tracking each page of each document portion, and compiling the documents portions to the original document.

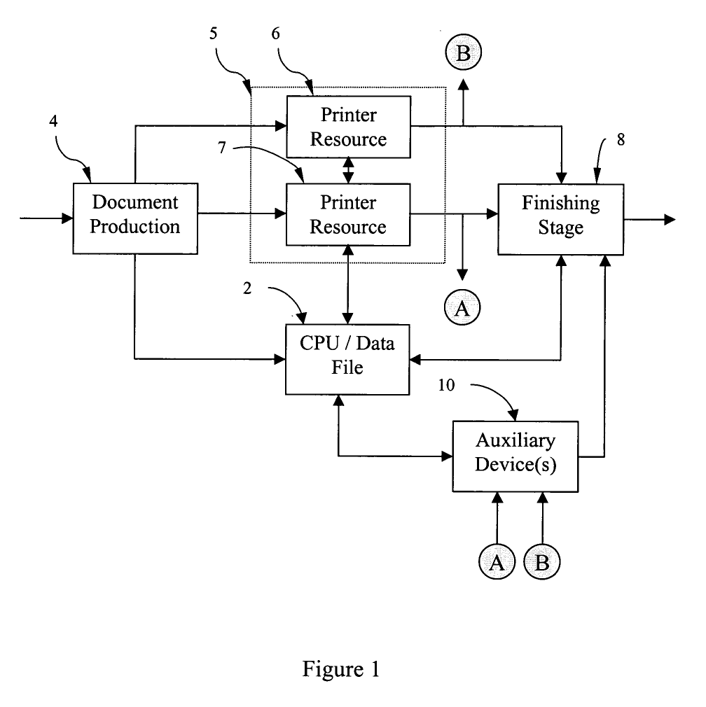

Reference now is made in detail to the presently preferred embodiments, examples of which are illustrated in the accompanying drawings and discussed below. FIG. 1 is a block diagram that illustrates a simplified print stream management system, by which one may print a document using multiple print resources, which keeps printing cost low, and automatically collates the document virtually eliminating the human interface.

The system is divided into three main areas, a document production stage 4, a printing stage 5, and a finishing stage 8. The document production stage 4 represents a document data processing system. This system may be a legacy system for generating a soft copy of types of statements, portfolios, or any other document type or document file. A user may create a document file representing a document to be created using the computer system. Also, the user may designate the appropriate printer for each portion of the document. In the alternative, the document file may be created automatically. In other words, software may be configured to determine the appropriate printer resource for each document portion, and direct each portion accordingly. In addition to representing the document to be created, the document file designates at least the workflow path of each document portion of the document to be created through the printing stage.

A processor (shown only in FIG. 1) maintaining a data file 2, communicates with and continually monitors each stage 4, 5, 8 of the system. The processor may include a computer having a storage medium, hardwire circuitry, a microprocessor, or any other type of device capable of maintaining the data file 2 and communicating with and continually monitoring each stage 4, 5, 8 of the system. Also, the processor may include multiple processors each for monitoring a respective stage 4, 5, 8, any part of a stage 4, 5, 8, or any combination of stages 4, 5, 8.

The data file 2 via the processor controls each stage 4, 5, 8, and may be continually updated with the process status as components of the document progress through each stage 4, 5, 8. After each printer 6, 7 completes the printing in printing stage 6, the document portion(s) is transferred to the finishing stage 8. During the finishing stage 8, the document portions of the document are collated together and matched with the data file 2 to verify document integrity. Output of respective printers 6, 7 may also be transferred to an auxiliary device 10. Auxiliary items, such as credit cards, check(s), labels, etc. may be included into a document package in the finishing stage 8 by the way of the auxiliary device 10. During the entire process, the processor and data file 2 track all portions of the process.

The finishing stage may include several assembly devices. The devices may include a print merge device. The assembly devices may include well known devices such as an insertion device for auxiliary items (“auxiliary device”), a device for folding and/or binding document pages, an inserter for placing finishing packages in enevelopes, and other types of finishing devices.

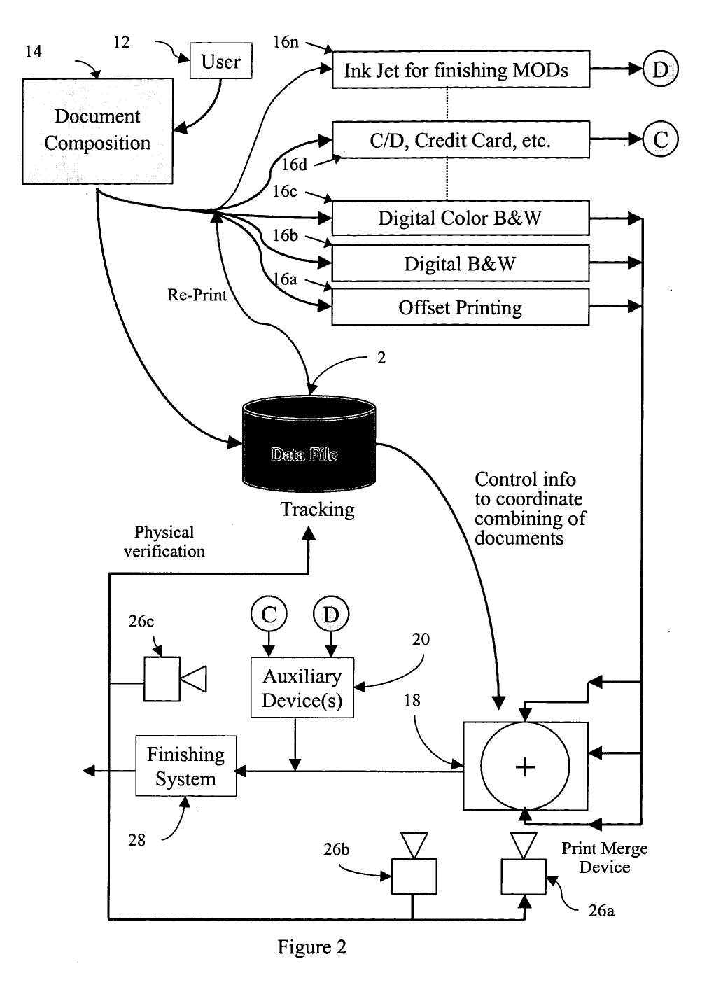

FIG. 2 is a block diagram illustrating in more detail an exemplary embodiment of the system described in connection with FIG. 1. At the front end, a user 12 creates a document file 14. The document file 14 may be any type of literature, which may include a personalized bank statement, a client's customized stock portfolio with colored graphs, a company's marketing information, etc. At the time the document file 14 is created, the user 12 may designate the print devices 16a-16n used to print selected portions of the document. Software may be configured to select and direct these portions to the appropriate printer 16a-16n. The selection step divides the original document file into a plurality of print files each corresponding to a respective print device 16a-n. Each print device 16a-n connected to receive and process the document portions according to a respective print file. A data file 2 is also created corresponding to the document file 14 for controlling and tracking the printing and compiling process.

As an example, a document having black and white text and color pictures may be printed entirely on-demand, using both a black and white printer 16b and a color printer 16c. Directing document portions to a plurality of printers reduces cost, as the user of the print stream management system is not required to run the entire document through a high-resolution color printer. In addition, job run times are reduced. Typically, higher quality printers have a slower processing time as compared to a lower quality printer. By dividing the document into portions, each portion of the document may be simultaneously printed. Therefore, the job run time is limited to the job run-time of the print device 16a-n requiring the most time to complete a respective portion.

After the completion of each print job, each document portion is transferred to a print merge device 18, an auxiliary device 20, or any other device for collating and/or finishing the document package. For ease of explanation, the print merge device 18 receives at least two document portions, and outputs a collated document. The collated document represents the final document if there is no other assembly or finishing required downstream from the print merge device.

Any suitable system may be used to transport each document portion from each printer 16a-16n to either the print merge device 18 or the auxiliary device 20. In some systems, it may be necessary to manually transfer bins of printed document portions from the printer 16a-n outputs to the inputs of the print merge device 18. However, it is envisioned that this transfer may also be automated.

The print merge device 18 collects each printed portion of the document, recevied from each of the various printers, and collates the document in accordance with the data file 2. Effectively, this device or module 18 merges document portions from the different print resources to compile a combined product. The auxiliary devices 20 insert or apply additional material, such as a credit card, to the collated document after the print merge device 18 collates document portions. In coordination with the data file 2, the processor tracks the output of each printer 16a-16n, directs and verifies the order by which the print merge device 18 collates the document, and directs and verifies auxiliary inserts are correctly matched and properly applied. In this way, the data file 2 insures the document is collated to match the document file 14 as originally created by the user 12. Results of each process step may also be added to the data file 2 as the document progresses through the system, to develop a record of verified document production and finishing.

In the event that an error occurs during collation, the processor may determine affected document portions and cause certain printers 16a-n to re-print the affected portions, and re-collate or insert the re-printed portions. If it is not possible or feasible to re-print only the affected portions, the processor may divert the current document and re-print all document portions.

The following discusses the system and method by which the data file 2 tracks each document and production equipment.

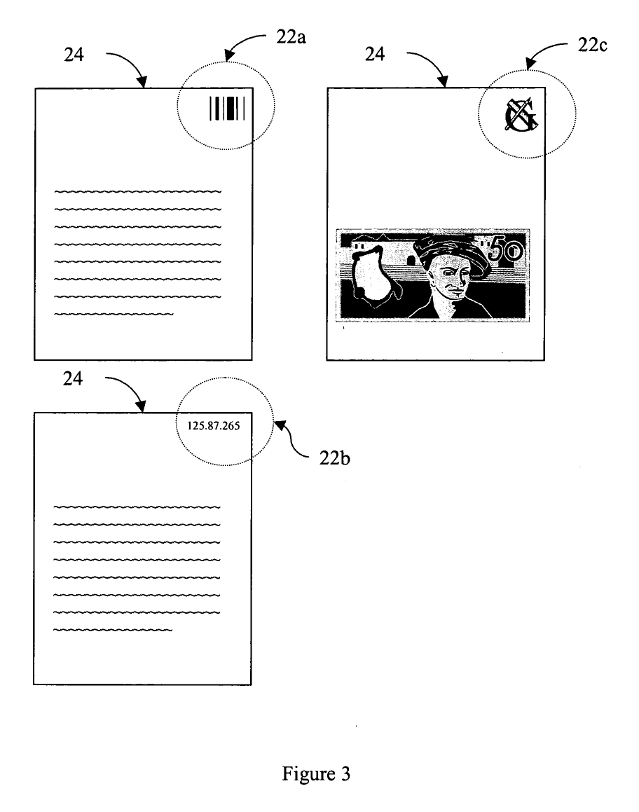

FIG. 3 illustrates examples of identifiers 22a-c positioned on each printed document page 24. Preferably, each page 24 of the document contains an identifier 22a-c, which indicates the page 28, the print source 16a-n to which the document is to be sent and/or the print source 16a-n from which the document was processed, the order by which the document is to be collated, and any other information pertinent to tracking and increasing integrity of a print management system. Such information may use various formats and contents, as will be appreciated by those or ordinary skill in the art.

As illustrated, each identifier 22a-c is positioned in the corner of each document page 24. The position of the identifier 22a-c is by the way of example, and the identifier may be positioned elsewhere on the document page 24, including the backside. These identifiers 22a-c may be in the form of a bar code 22a, a symbol 22c, and/or a number 22b. Other types of identifiers may become apparent to those of ordinary skill in the art. Each identifier 22a-c may be unique to the particular document page 24 or may a represent a common document page 24. For instance, a inventory statement may be identified by a unique identifiers 22a-c, such as a bar code 22a or number 22b. Or, a general document which is to be included in each statement may be identified by the company's logo 22c. A combination of the aforementioned identifiers 22a-c may be placed on each document page 24 as well.

In addition to identifying the page 24 type, identifiers 22a-c may also represent the workflow. That is, each identifier 22a-c may also represent the process by which the respective document page 24 will flow through the respective print management system. For instance, an identifier 22a-c could represent the print device 16a-n which prints the respective page 24 and/or the order by which the respective page 24 is to be collated with other pages 24 processed by the system. In other words, the workflow identifies not only what documents come together and in what sequence but also the order.

Identifiers 22a-c printed by the respective device or pre-printed on input sheets contain the information required to track the respective document and compile all document pages 24 in the correct order. Each print device 16a-n directs the respective output (document portion) to the print merge 18 device or an auxiliary device 20. The aforementioned data file 2 created at the front end of the print management system stores all information corresponding to the identifiers 22a-c. In essence, the data file 2 is a compilation of information represented by the identifiers 22a-c. Control systems of the merge device and other stations may control the operations in response to data derived from election of the identifiers 22a-c or in response to instructions derived from the data file 2.

A scanning device is configured to read each type of identifier 22a-c. The scanning device may be employed to detect and read a bar code 22a. The scanning device may be employed with a camera, which may be configured for character recognition to read a number identifier 22b. The scanning device may also be configured to detect graphics 22c, such as a company's logo. Various types of scanning devices are known to those of ordinary skill in the art and are not limited to the aforementioned examples.

Referring back to FIG. 2, as illustrated, cameras 26a-c representing the aforementioned scanning devices positioned throughout the finishing stage. In the embodiment, one camera 26a is positioned corresponding to the print merge device 18. A second camera 26b is positioned between the print merge device 18 and the finishing system 28, and a third camera 26c is positioned by the auxiliary device(s) 20 input.

A page of the document may correspond to a primary or control document, preferably identified by an appropriate one of the identifiers 22a-c. When the cameras 26a-c detects a primary document, the associated data file 2 is accessed. This data file 2 contains all information required to compile the document in the correct order, the print device 16a-n from which each document portion was delivered, the types of codes printed on each page of the document, etc. When the primary document is loaded, the print merge device 18 collates the document according to the data file 2. In order to increase the integrity of the process, camera detects 26a each identifier 22a-c of the document page as the document is being collated. The processor (discussed below) tracks each and every page collated into the document and cross-checks with the data file 2 to insure the correct page is associated with the correct primary document and collated in the correct order. In the instance where a page is collated out of order or collated with the inappropriate primary document, the CPU will detect such by comparing the identifier with the data file 2. A signal may be sent to an operator indicating that an error has occurred, or the print job may be diverted from the finishing system 28. Once the print merge device 18 collates the document, the print merge device 18 releases the collated document.

An auxiliary device(s) 20 may be used to insert or apply any of a plurality of auxiliary item, such as a credit card or a shipping label. For instance, the print devices 16a-n could include a label printer, the output of which is forwarded to the auxiliary device 20. The auxiliary device 20 may be a label applicator that applies labels to each envelope or package. Therefore, after the document is collated, a label may be applied to the appropriate envelope or package thereby completing the print job.

The second camera 26b detects the primary document once released by the print merge device 18. The processor again accesses the corresponding data file 2 and determines if any auxiliary item are required. In the case where an auxiliary item is required, the CPU queues the auxiliary device 20. Once the document enters an auxiliary staging area, an auxiliary item is collated on the document.

The third camera detects 26c the auxiliary item insert before insertion into the document, after the insertion, or a combination of both. In this way, integrity is increased, as the data file 2 is again accessed to verify the correct auxiliary item is applied to the correct document. This is done by comparing the primary document with the auxiliary item to be included in the envelope or package.

As mentioned above, a label may be applied to the document or envelope into which the document is to be inserted. The label preferably will have an identifier 22a-c, which corresponds to a respective primary document. A fourth camera (not shown) may detect the label to be placed on the respective document. Also, the aforementioned third camera 26c may be configured to detect the respective item insert. The data file 2 is again accessed by the processor to verify that the correct label is placed on the correct document, envelope, or both. Once verified, the labeler applies the label. After all auxiliary items are included in the document, the document is transferred to the finishing system 28, for example, for folding, binding and/or insertion into an envelope.

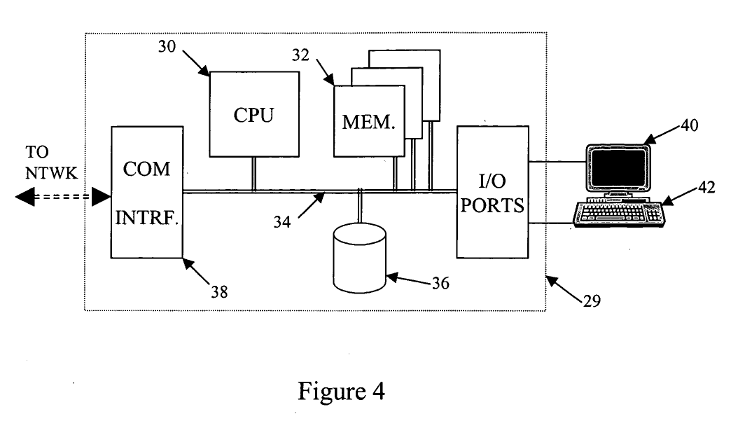

FIG. 4 is a functional block diagram of a PC or workstation type general purpose computer which may embody the processor. The computer may be used for document file 14 composition and/or for creating and maintaining the data file 2 and tracking the document.

The exemplary computer system 29 contains a central processing unit (CPU) 30, memories 32, and an interconnect bus 34. The CPU 30 may contain a single microprocessor, or may contain a plurality of microprocessors for configuring the computer system 29 as a multi-processor system. The memories 32 include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the CPU 22.

The mass storage 36 may include one or more magnetic disk or tape drives or optical disk drives, for storing data and instructions for use by CPU 30. For a workstation PC, for example, at least one mass storage system 36 in the form of a disk drive or tape drive, stores the operating system and application software as well as the data file 2. The mass storage 36 within the computer system 29 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 29.

The system 29 also includes one or more input/output interfaces 38 for communications, shown by way of example as an interface for data communications via the network. The interface may be a modem, an Ethernet card or any other appropriate data communications device. The physical communication links may be optical, wired, or wireless. If used for document composition, the communications enable the system 29 to forward print files to the printers 16a-n. If used to store the data file 2 and track processing the network enables the communications with the other system elements as outlined above.

The computer system may further include appropriate input/output ports for interconnection with a display 40 and a keyboard 42 serving as the respective user interface. For example, the computer may include a graphics subsystem to drive the output display. The output display may include a cathode ray tube (CRT) display or liquid crystal display (LCD). Although not shown, the PC type system typically would include a port for connection to a printer. The input control devices for such an implementation of the system would include the keyboard for inputting alphanumeric and other key information. The input control devices for the system may further include a cursor control device (not shown), such as a mouse, a touchpad, a trackball, stylus, or cursor direction keys. The links of the peripherals to the system may be wired connections or use wireless communications.

The system 29 is shown and discussed as an example only of a platform supporting several of the above-discussed processing and control functions. The document composition functions and the computer processing operations relating to data file 2 may reside on a single computer system, or two separate systems; or one or both of these functions may be distributed across a number of computers.

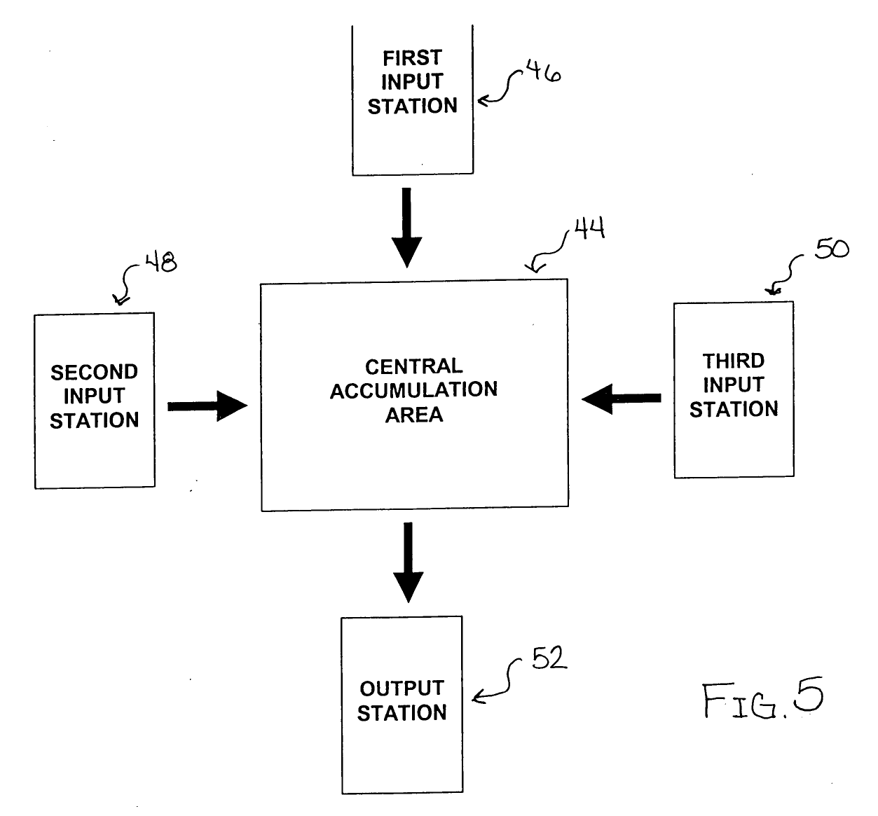

FIG. 5 illustrates a basic block diagram of the print merge device 18. Reference is made to U.S. patent application Ser. No. 10/359,928, entitled “APPARATUS AND METHOD FOR ASSEMBLING A STACK OF SHEET ARTICLES FROM MULTIPLE INPUT PATHS”, and is incorporated herein as a reference. A brief description of the disclosed subject matter follows.

With respect to FIG. 5, the print merge device may include inputs for sheet articles on three sides of a central accumulation area 44, such as one upstream input 46 and two side-stream inputs 48, 50, and an output station 52 on the fourth side of the central accumulation area 44. A variety of inputs can be used as desired to advance sheet articles from different sheet streams into the central accumulation area 44, and the output mechanism or device can be angled to facilitate the exit of material to downstream devices. The input sheet material is accumulated in the central accumulation area 44 preferably in an over-accumulation manner, in proper sequence as directed by the CPU 28 in accordance with the data file 2. Each input 46, 48, 50 can have read capability and can be free-flowing, transport type, or a staged input wherein a single sheet or set of sheets can be stopped or staged for a desired amount of time prior to the advancement of the sheet articles into the central accumulation area 44. By having the input stages 46, 48, 50, system throughput can be optimized and jam removal and data reconciliation can be simplified, as can be appreciated by those of skill in the art.

Each input 46, 48, 50 can be adjustable so as to handle a full range of paper, including both landscape and portrait formats. If sheet material from side-stream inputs 48, 50 are transported into the central accumulation area 36 in landscape format, then the orientation of the material from the output station 52 will be portrait and vice-versa. Sheet material that has been merged in the central accumulation area will all be of the same approximate size and can be registered in all three dimensions to ensure square stack upon exit. The material stack can be either centerline or right edge justified, depending on the downstream device requirements. Additionally, each subsequent set can be registered to alternating sides making it easier to singulate the output. The accumulated stack in the central accumulation area can then be discharged through the output stage 52 and advanced for downstream processing. Any suitable mechanism can be used for advancing the accumulated sheet stack from the central accumulation area, such as, for example, push pins on a conveyor system and/or output path nip rollers.

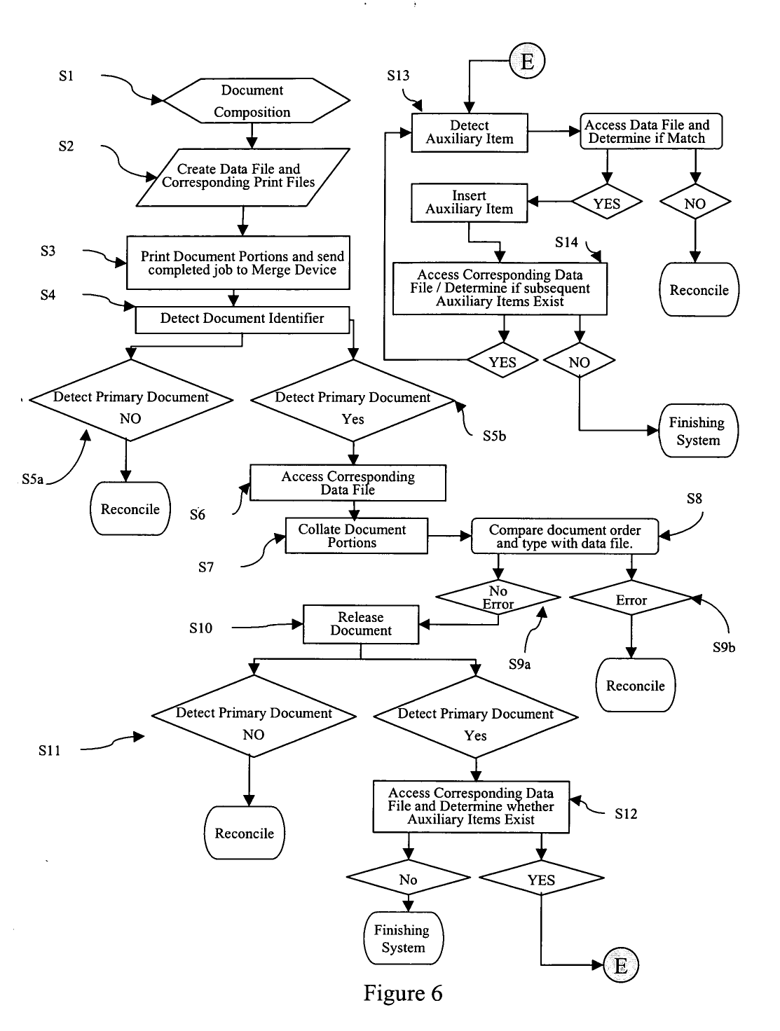

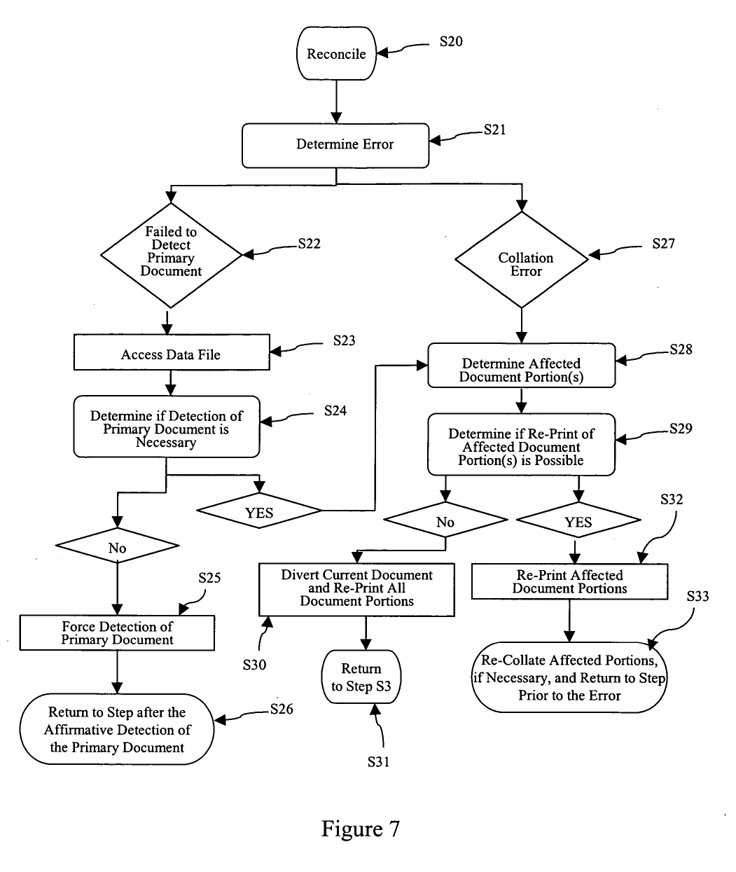

FIG. 6 illustrates a flow chart of the process by which the document is printed and collated. In S1, the user creates a document file 14. During S2, a data file 2 and print files are created corresponding to the document file 14 created in S1. In S3, each portion of the document is printed in accordance with the print files created in S2, the output being transferred to the print merge device 18. Then first camera 26a reads the document portions transferred from the print devices 16a-n until the primary or control document is detected S5b. If the primary document is not detected S5a, the error is reconciled (FIG. 7). If detected, the data file 2 corresponding to the primary document is accessed in S6, and the print merge device 18 collates the document S7 corresponding to the data file 2 accessed in S6. Each identifier of each document page or a group of document pages is read during compilation in step S7 and is compared S8 with the information stored by the data file 2. If a document page is inserted out of order or is not associated with the primary document, an error signal is generated S9b, and the error is reconciled (FIG. 7). If no error occurs S9a, the collated document is released and transferred to the next stage S10. Second camera 26b detects the primary document and the corresponding data file 2 is accessed S11. If the primary document is not detected, the error is reconciled (FIG. 7). If properly detected, the system determines whether auxiliary item inserts should be added. If the determination is negative, the document is transferred to finishing system 28, such as binder or inserter. If auxiliary materials are to be inserted, third camera 26c detects the next auxiliary item S13. If the detected auxiliary item matches the information contained in the data file 28, the auxiliary item is inserted S14. If an incorrect match occurs, the error is reconciled (FIG. 7). If a label is to be placed on the document, S13 and S14 are performed again. In other words, auxiliary items will be continually applied to the document until no other auxiliary items exist for a respective document package. Thus, once all auxiliary materials have been applied, the document is transferred to the finishing system 28.

FIG. 7 illustrates a flow chart of the process by which an error is reconciled S20. At any time during processing the document an error is detected, the system may divert the document for inspection. In the alternative, the error may be automatically reconciled. First, the type of error is determined S21 typically by an error message generated by the processor. In the event a scanner 26a-c failed to detect a primary document S22, the data file 2 may be accessed S23 to determine if detection of the primary document is necessary S24 for the current print job. If the current print job does not require the detection of a primary document, the processor forces a primary document detection for all detection equipment downstream from where the error occurred. In other words, when a scanner 26a-c downstream does not detect a primary document, the reconciliation process need not be repeated, and a primary document detection is forced. In the event that primary document is required, the processor determines the affected document portion or portions S28, discussed further below.

In the event there is a collation error S27, which may include any type of error in the finishing system, the processor determines affected document portions S28. In other words, the processor determines which document portions need be re-printed and advanced to the current position in the finishing system S28. To put it another way, the processor determines if re-print of affected document portions is possible S28. If not, the current document will be diverted, and the entire document is re-printed, returning to step S3 of FIG. 6 (S30, S31). If re-print of affected document portions is possible, the affected portions are reprinted S32 by respective printers 16a-n. The re-printed documents are collated, if necessary, and advanced up until the error occurred, where the collation continues. In this way, only the affected portions need be re-printed, which increases system efficiency, speed, etc.

Other unique aspects relate to unique software or program products, for implementing the print stream management system. A software or program product includes information, which may be carried by at least one machine-readable medium. The information carried by the medium may be executable code, one or more databases and/or information regarding management print streams. In disclosed embodiments, the information comprises executable code for causing one or more programmable computer systems to implement management of multiple print streams.

A computer readable medium, as used herein, may be any physical element or carrier wave, which can bear instructions or code for performing a sequence of steps in a machine-readable form or associated data. Examples of physical forms of such media include floppy disks, flexible disks, hard disks, magnetic tape, any other magnetic medium, a CD-ROM, any other optical medium, a RAM, a ROM, a PROM, an EPROM, a FLASH-EPROM, any other memory chip or cartridge, as well as media bearing the software in a scannable format. A carrier wave type of medium is any type of signal that may carry digital information representative of the data or the instructions or code for performing the sequence of steps. Such a carrier wave may be received via a wireline or fiber-optic network, via a modem, or as a radio-frequency or infrared signal, or any other type of signal which a computer or the like may receive and decode.

Terms relating to computer or machine “readable medium” as used herein refer to any medium that participates in providing instructions to a processor for execution or for carrying data to or from a processor for storage or manipulation. Such a medium may take many forms, including but not limited to, non-volatile media, volatile media, and transmission media. Non-volatile media include, for example, optical or magnetic disks. Volatile media include dynamic memory, such as main memory. Transmission media include coaxial cables; copper wire and fiber optics, including the wires that comprise a bus within a computer system. Transmission media can also take the form of electric or electromagnetic signals, or acoustic or light waves such as those generated during radio frequency (RF) and infrared (IR) data communications. Common forms of computer or machine readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other medium from which a computer can read. Various forms of computer or machine readable media may be involved in carrying one or more sequences of one or more instructions or data to a processor for execution.

While the foregoing has described what are considered to be the best mode and/or other preferred embodiments, it is understood that various modifications may be made therein and that the invention or inventions disclosed herein may be implemented in various forms and embodiments, and that they may be applied in numerous applications, only some of which have been described herein.

What is claimed is:

1. A multiple print stream management system comprising:
a document data processing system for generating a soft-copy of a document to be created and for generating a print file therefrom for each document portion of the document to be created;
a printing stage including a plurality of printers each operable in accordance with a respective print file received from the document data processing system, each printer for printing the document portion in accord with the respective print file;
a finishing stage including one or more assembly devices for processing an output of each of the plurality of printers for collating the document portions into a final document corresponding to the document to be created; and
a processor for tracking each document portion and for directing collation thereof in accordance with intended attributes of the final document.

2. The multiple print stream management system according to claim 1 wherein the one or more assembly devices includes a print merge device for collating at least two document portions into a collated document in accordance with the attributes of the final document.

3. The multiple print stream management system according to claim 2, wherein the processor tracks and directs collation of the at least two document portions collated by the print merge device.

4. The multiple print stream management system according to claim 2, wherein the one or more assembly devices includes an auxiliary device downstream from the print merge device for applying an auxiliary item to the collated document in accordance with the attributes of the final document.

5. The multiple print stream management system according to claim 1, further comprising one or more scanning devices positioned in the finishing stage for detecting an identifier on each document page or on a group of document pages of the document portions.

6. The multiple print stream management system according to claim 5, wherein the processor is configured to compare the detected identifier with the attributes of the final document for verifying collation of the document portions.

7. The multiple print stream management system according to claim 6, wherein in the event of an error in collation, the processor is configured to cause at least one printer of the printing stage to re-print at least one affected document portion of the document portions.

8. The multiple print stream management system according to claim 6, wherein in the event of an error in collation, the processor is configured to cause each printer to print the document portion in accord with the respective print file.

9. A multiple print stream management system for managing production of a document to be created divided into document portions, comprising:
a printing stage including a plurality of printers each for printing a respective document portion of the document to be created;
a finishing stage including one or more assembly devices for processing an output of each of the plurality of printers for collating the document portions into a final document corresponding to the document to be created; and
a processor for tracking each document portion and for directing collation of the document portions in accordance with intended attributes of the final document specified in a data file for the document to be created.

10. The multiple print stream management system according to claim 9, further comprising one or more scanning devices positioned in the finishing stage for detecting an identifier representing document attributes on each document page or on a group of document pages of the document portions.

11. The multiple print stream management system according to claim 10, wherein the processor is configured to compare the detected identifier with the attributes of the final document specified in the data file for verifying collation of the document portions.

12. The multiple print stream management system according to claim 11, wherein in the event of an error in collation, the processor is configured to cause at least one printer of the printing stage to re-print at least one affected document portion of the document portions.

13. The multiple print stream management system according to claim 11, wherein in the event of an error in collation, the processor is configured to cause each printer to print the document portion.

14. The multiple print stream management system according to claim 9, wherein the one or more assembly devices includes a print merge device for collating at least two document portions into a collated document.

15. The multiple print stream management system according to claim 14, further comprising a scanning device positioned corresponding to the print merge device for detecting an identifier on each document page or on a group of documents pages of the at least two document portions.

16. The multiple print stream management system according to claim 14, wherein the one or more assembly devices includes an auxiliary device for receiving the collated document and for applying an auxiliary item to the collated document.

17. The multiple print stream management system according to claim 16, further comprising a scanning device positioned corresponding to the auxiliary device for detecting an identifier on the auxiliary item.

18. The multiple print stream management system according to claim 9, further comprising a computer for producing a document file representing the document to be created.

19. The multiple print stream management system according to claim 18, wherein the computer creates a print file from the document file for each document portion, each printer receiving a respective print file for printing a respective document portion of the document to be created.

20. The multiple print stream management system according to claim 18, wherein the computer creates the data file containing final document attributes.

21. The multiple print stream management system according to claim 9, wherein the data file maintains attributes represented by the identifier selected from a group consisting of a document page, a printer of the plurality of printers to which the document page or the group of document pages is to be sent, a printer of the plurality of printers from which the document page or the group of document pages was processed, the order by which the document page or group of document pages is to be collated, a predetermined path through the printer stage which the document page or the group of document pages will progress, a predetermined path through the finishing stage which the document page or the group of document pages will progress, and any combination thereof.

22. A method for collating and tracking portions of a document to be created from multiple print resources, comprising the steps of:
generating multiple print files from a soft copy of the document to be created;
printing document portions from the multiple print files;
collating the document portions into a final document corresponding to the document to be created;
detecting an identifier on each document page or a group of document pages of the document to be created; and
verifying collation of the document portions in accordance with the detected identifier.

23. A method for collating and tracking portions of a document to be created from multiple print resources, comprising the steps of:
compiling attributes of a final document corresponding to the document to be created;
obtaining from multiple print resources portions of the document to be created;
collating the document portions into the final document;
detecting an identifier on each document page or a group of document pages of the document to be created;
comparing the detected identifier with the compiled final document attributes; and
verifying collation of the document portions from the comparison.

24. The method according to claim 23 wherein the collating step includes the step of collating at least two document portions of the document to be created into a collated document according to the final document attributes.

25. The method according to claim 24, wherein the collating step includes applying an auxiliary item to the collated document to form the final document in accordance with the final document attributes.

26. The method according to claim 23, wherein the step of compiling final document attributes includes creating a data file.

27. The method according to claim 26, further comprising the step of populating data in the data file corresponding to the detected identifier.

28. The method according to claim 23, further comprising the step of identifying a primary document from the detected identifier.

29. The method according to claim 28, further comprising the step of accessing a data file according to the detected primary document identifier.

30. The method according to claim 23, further comprising determining the order of collation from final document attributes in accordance with the detected identifier.

31. The method according to claim 23, further comprising the step of determining whether any auxiliary item inserts should be applied to a collated document corresponding to the detected identifier.

32. The method according to claim 31, further comprising the step of detecting an identifier on the auxiliary item.

33. The method according to claim 32, further comprising verifying the auxiliary item insert corresponds to the collated document.

34. The method according to claim 23, wherein in the event of an error in collation, re-obtaining at least one affected document portion from at least one printer resource.

35. The method according to claim 23, wherein in the event of ah error in collation, re-obtaining from the multiple print resources the portions of the document to be created.

36. A program product, comprising executable code transportable by at least one machine readable medium, wherein execution of the code by at least one programmable computer causes the at least one programmable computer to perform the sequence of steps, comprising:
receiving workflow data of document portions of a document to be created originating from multiple document steams;
comparing the workflow data with intended final document attributes of the document to be created; and
controlling collation of the document portions based on the comparison, to create a finished document in accord with the intended final document attributes.

37. The program product according to claim 36, wherein to enable correct collation of the document portions, automatically halting collation of the document portions when workflow data does not correspond to the final document attributes.

38. The program product according to claim 36, wherein in the event of an error, causing affected document portions to be re-printed.

39. The program product according to claim 36, wherein in the event of an error, causing all document portions to be re-printed.

40. The program product according to claim 36, further comprising storing the workflow data within the at least one programmable computer.

41. A computer control system for controlling collation of document portions originating from multiple document streams into a final document, comprising:
a computer for receiving data representing attributes of each document page or a group of document pages of each document portion, the computer for tracking the document portions originating from each document stream; and
a stored data file for maintaining attributes of the final document, the stored data file being accessible by the computer,
wherein the computer compares received data with final document attributes for controlling collation of the document portions and verifying collation thereof.

42. The computer control system according to claim 41, further comprising a scanning device in communication with the computer, the scanning device configured to detect an identifier on each document page or the group of document pages and supply the detected identifier data to the computer.

43. The computer control system according to claim 41, wherein the computer stores data responsive to identifier detection in the data file.
